(19) United States
(12) Patent Application Publication
(10) Pub. No.: US 2016/0197780 A1
(43) Pub. Date: Jul. 7, 2016

(54) METHOD AND APPARATUS FOR TRANSMITTING CONFIGURATION INFORMATION

(71) Applicant: Samsung Electronics Co., Ltd., Gyeonggi-do (KR)

(72) Inventors: Jun-Hak Lim, Gyeonggi-do (KR); Hyuk Kang, Gyeonggi-do (KR); Su-Hyun Kim, Gyeonggi-do (KR); Ju-Ah Lee, Gyeonggi-do (KR); Young-Jae Choi, Gyeonggi-do (KR)

(21) Appl. No.: 14/980,550

(22) Filed: Dec. 28, 2015

(30) Foreign Application Priority Data
Jan. 6, 2015 (KR) 10-2015-0001454

(51) Int. Cl. H04L 12/24; H04L 29/08

(52) U.S. Cl. CPC H04L 41/0806; H04L 67/1097

(57) ABSTRACT

Provided is a method for transmitting configuration information to a media device by an electronic device. The method includes receiving a signal comprising information associated with the media device, obtaining configuration information available for configuring the media device based on the received signal, and transmitting the obtained configuration information to the media device.

### CLAIM OF PRIORITY

This application claims the benefit under 35 U.S.C. §119(a) of a Korean patent application filed in the Korean Intellectual Property Office on Jan. 6, 2015 and assigned Serial No. 10-2015-0001454, the entire disclosure of which is incorporated herein by reference.

### TECHNICAL FIELD

The present disclosure relates to electronic devices, in general, and more particularly to a method and apparatus for transmitting of configuration information.

### BACKGROUND

Recently, electronic devices (e.g., smart televisions (TVs), smartphones, tablet personal computers (PCs), wearable devices, and so forth) provide various functions to users. For example, electronic devices may not only simply provide audio and/or video contents, but also share contents and/or information with other electronic devices through wireless communication and provide the shared contents and/or information to users. The users may configure a driving environment suitable for each function provided by the electronic devices and receive various contents and/or information in a desired manner according to the configured driving environment.

At the time of initial driving of the electronic device or re-configuration of the electronic device, the user has to directly configure a driving environment for various functions provided by the electronic device. Moreover, the user has to perform different configuring processes, depending on types of electronic devices. In addition, if an input device of an electronic device is limited, the configuring process needs to be performed using the limited input device, increasing user's inconvenience.

The above information is presented as background information only to assist with an understanding of the present disclosure. No determination has been made, and no assertion is made, as to whether any of the above might be applicable as prior art with regard to the present disclosure.

### SUMMARY

According to aspects of the present disclosure, a method is provided for transmitting configuration information to a media device by an electronic device, the method including receiving a signal comprising information associated with the media device, obtaining configuration information available for configuring the media device based on the received signal, and transmitting the obtained configuration information to the media device if the configuration information is obtained.

According to aspects of the present disclosure, an electronic device is provided for transmitting configuration information to a media device, the electronic device including a communication module configured to receive a signal comprising information associated with the media device and a processor configured to obtain configuration information available for configuring the media device based on the received signal and to transmit the obtained configuration information to the media device if the configuration information is obtained.

According to aspects of the present disclosure, a method is provided for configuring a first electronic device, the method including broadcasting, by the first electronic device, a signal comprising information associated with the first electronic device, receiving, by the first electronic device, configuration information transmitted by a second electronic devise in response to receiving the signal, determining configuration information available for configuring the first electronic device among the received configuration information, and configuring the first electronic device based on the determined configuration information available for configuring the first electronic device.

According to aspects of the present disclosure, a first electronic device is provided, the first electronic device including a communication module configured to broadcast a signal comprising information associated with the first electronic device and to receive configuration information transmitted by a second electronic device in response to receiving the signal and a processor configured to determine configuration information available for configuring the first electronic device among the received configuration information and to configure the first electronic device based on the determined configuration information available for configuring the first electronic device.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

Throughout the drawings, it should be noted that like reference numbers are used to depict the same or similar elements, features, and structures, wherein:

FIG. 1 is a diagram of an example of a network environment, according to an embodiment of the present disclosure;

FIG. 2 is a block diagram of an example of a program module, according to an embodiment of the present disclosure;

FIG. 3 is a block diagram of an example of a media device, according to an embodiment of the present disclosure;

FIG. 4 is a flowchart of an example of a process, according to an embodiment of the present disclosure;

FIG. 5A is a diagram of an example of a system, according to an embodiment of the present disclosure;

FIG. 5B is a diagram of an example of a system, according to an embodiment of the present disclosure;

FIG. 6 is a diagram of an example of a system, according to an embodiment of the present disclosure;

FIG. 7A is a diagram of an example of a user interface for configuring a media device, according to an embodiment of the present disclosure;

FIG. 7B is a diagram of an example of a user interface for configuring a media device, according to an embodiment of the present disclosure;

FIG. 8 is a flowchart of an example of a process, according to an embodiment of the present disclosure;

FIG. 9 is a flowchart of an example of a process, according to an embodiment of the present disclosure;

FIG. 10 is a flowchart of an example of a process, according to an embodiment of the present disclosure;

FIG. 11 is a flowchart of an example of a process, according to an embodiment of the present disclosure;

FIG. 12 is a flowchart of an example of a process, according to an embodiment of the present disclosure;

FIG. 13 is a flowchart of an example of a process, according to an embodiment of the present disclosure;

FIG. 14 is a flowchart of an example of a process, according to an embodiment of the present disclosure;

FIG. 15 is a flowchart of an example of a process, according to an embodiment of the present disclosure;

FIG. 16 is a sequence diagram of an example of a process, according to an embodiment of the present disclosure;

FIG. 17 is a sequence diagram of an example of a process, according to an embodiment of the present disclosure; and

FIG. 18 is a block diagram of an example of an electronic device, according to an embodiment of the present disclosure.

Throughout the drawings, like reference numerals will be understood to refer to like parts, components, and structures.

### DETAILED DESCRIPTION

Hereinafter, various embodiments of the present disclosure will be disclosed with reference to the accompanying drawings. However, the present disclosure is not intended to limit the present disclosure to particular embodiments, and it should be construed as including various modifications, equivalents, and/or alternatives according to the embodiments of the present disclosure. In regard to the description of the drawings, like reference numerals refer to like elements.

In the present disclosure, an expression such as “having,” “may have,” “comprising,” or “may comprise” indicates the existence of a corresponding characteristic (such as an element such as a numerical value, function, operation, or component) and does not exclude the existence of additional characteristic.

In the present disclosure, an expression such as “A or B,” “at least one of A or/and B,” or “one or more of A or/and B” may include all possible combinations of together listed items. For example, “A or B,” “at least one of A and B,” or “one or more of A or B” may indicate the entire of (1) including at least one A, (2) including at least one B, or (3) including both at least one A and at least one B.

Expressions such as “first,” “second,” “primarily,” or “secondary,” used in various exemplary embodiments may represent various elements regardless of order and/or importance and do not limit corresponding elements. The expressions may be used for distinguishing one element from another element. For example, a first user device and a second user device may represent different user devices regardless of order or importance. For example, a first element may be referred to as a second element without deviating from the scope of the present disclosure, and similarly, a second element may be referred to as a first element.

When it is described that an element (such as a first element) is “operatively or communicatively coupled” to or “connected” to another element (such as a second element), the element can be directly connected to the other element or can be connected to the other element through a third element. However, when it is described that an element (such as a first element) is “directly connected” or “directly coupled” to another element (such as a second element), it means that there is no intermediate element (such as a third element) between the element and the other element.

An expression “configured to (or set)” used in the present disclosure may be replaced with, for example, “suitable for,” “having the capacity to,” “designed to,” “adapted to,” “made to,” or “capable of” according to a situation. A term “configured to (or set)” does not always mean only “specifically designed to” by hardware. Alternatively, in some situation, an expression “apparatus configured to” may mean that the apparatus “can” operate together with another apparatus or component. For example, a phrase “a processor configured (or set) to perform A, B, and C” may be a generic-purpose processor (such as a CPU or an application processor) that can perform a corresponding operation by executing at least one software program stored at an exclusive processor (such as an embedded processor) for performing a corresponding operation or at a memory device.

Terms defined in the present disclosure are used for only describing a specific exemplary embodiment and may not have the intention to limit the scope of other exemplary embodiments. When using in a description of the present disclosure and the appended claims, a singular form may include a plurality of forms unless it is explicitly differently represented. Entire terms including a technical term and a scientific term used here may have the same meaning as a meaning that may be generally understood by a person of common skill in the art. It may be analyzed that generally using terms defined in a dictionary have the same meaning as or a meaning similar to that of a context of related technology and are not analyzed as an ideal or excessively formal meaning unless explicitly defined. In some case, terms defined in the present disclosure cannot be analyzed to exclude the present exemplary embodiments.

An electronic device according to various embodiments of the present disclosure may be a device including a communication function. For example, the electronic device may include at least one of a smartphone, a tablet Personal Computer (PC), a mobile phone, a video phone, an electronic book (e-book) reader, a desktop PC, a laptop PC, a netbook computer, a Personal Digital Assistant (PDA), a Portable Multimedia Player (PMP), an MP3 player, mobile medical equipment, a camera, and a wearable device (e.g., smart glasses, a Head-Mounted Device (HMD), an electronic cloth, an electronic bracelet, an electronic necklace, an appcessory, an electronic tattoo, a smart mirror, or a smart watch).

According to some embodiments, the electronic device may be a smart home appliance. The home appliance may include, for example, at least one of a Television (TV), a Digital Video Disk (DVD) player, audio equipment, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, and an electronic frame.

According to another embodiment, the electronic device may include at least one of various medical equipment (e.g., various portable medical measurement systems, such as a blood sugar measurement device, a heartbeat measurement device, a blood pressure measurement device, or a body temperature measurement device, Magnetic Resonance Angiography (MRA), Magnetic Resonance Imaging (MRI), Computed Tomography (CT), an imaging device, or an ultrasonic device), a navigation system, a Global Positioning System (GPS) receiver, an Event Data Recorder (EDR), a Flight Data Recorder (FDR), a vehicle infotainment device, electronic equipment for ships (e.g., navigation system and gyro compass for ships), avionics, a security device, a vehicle head unit, an industrial or home robot, an Automatic Teller's Machine (ATM), a Point of Sales (POS), Internet of things (e.g., electric bulbs, various sensors, electricity or gas meters, sprinkler devices, fire alarm devices, thermostats, streetlights, toasters, exercise machines, hot-water tanks, heaters, boilers, etc.).

According to some embodiments, the electronic device may include a part of a furniture or building/structure, an electronic board, an electronic signature receiving device, a projector, and various measuring instruments (e.g., water, electricity, gas, or electric wave measuring device). The electronic device according to various embodiments of the present disclosure may be one of the above-listed devices or a combination thereof. The electronic device according to various embodiments of the present disclosure may be a flexible device. It will be obvious to those of ordinary skill in the art that the electronic device according to various embodiments of the present disclosure is not limited to the above-listed devices and may include new electronic devices according to technical development.

Hereinafter, an electronic device according to various embodiments of the present disclosure will be described with reference to the accompanying drawings. Herein, the term “user” used in various embodiments of the present disclosure may refer to a person who uses the electronic device or a device using the electronic device (e.g., an artificial intelligence electronic device).

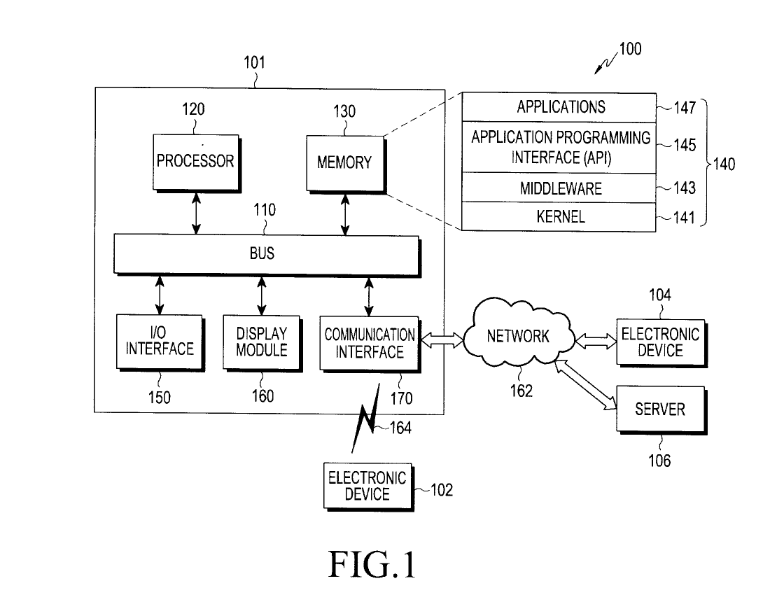

FIG. 1 is a diagram of an example of a network environment, according to an embodiment of the present disclosure. Referring to FIG. 1, a description will be made of an electronic device 101 in a network environment 100 according to various embodiments of the present disclosure. The electronic device 101 may include at least one of a bus 110, a processor 120, a memory 130, an I/O interface 150, a display module 160, and a communication module 170. According to some embodiments, the electronic device 101 may omit at least one of the foregoing elements or may further include other elements.

The bus 110 may include a circuit for interconnecting the elements 120 through 170 described above and for allowing communication (e.g., a control message and/or data) between the elements 120 through 170.

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. The processor 120 performs operations or data processing for control and/or communication of, for example, at least one other elements of the electronic device 101. The processor 120 may be referred to as a controller or may include the controller as a part thereof.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 130 may include a volatile and/or nonvolatile memory. The memory 130 may store, for example, commands or data associated with at least one other elements of the electronic device 101. According to an embodiment of the present disclosure, the memory 130 may store software and/or a program 140. The program 140 may include, for example, a kernel 141, middleware 143, an Application Programming Interface (API) 145, and/or application program (or an application) 147. At least some of the kernel 141, the middleware 143, and the API 145 may be referred to as an Operating System (OS).

The kernel 141 controls or manages, for example, system resources (e.g., the bus 110, the processor 120, or the memory 130) used to execute an operation or a function implemented in other programs (e.g., the middleware 143, the API 145, or the application program 147). The kernel 141 provides an interface through which the middleware 143, the API 145, or the application program 147 accesses separate components of the electronic device 101 to control or manage the system resources.

The middleware 143 may work as an intermediary for allowing, for example, the API 145 or the application program 147 to exchange data in communication with the kernel 141. In regard to task requests received from the application program 147, the middleware 143 may perform control (e.g., scheduling or load balancing) with respect to the task requests, for example, by giving priorities for using a system resource (e.g., the bus 110, the processor 120, or the memory 130) of the electronic device 101 to at least one of the application programs 147.

The API 145 is an interface used for the application 147 to control a function provided by the kernel 141 or the middleware 143, and may include, for example, at least one interface or function (e.g., a command) for file control, window control, image processing or character control.

Herein, an application may also be referred to as an application program.

The I/O interface 150 serves as an interface for delivering a command or data input from a user or another external device to other element(s) of the electronic device 101. The I/O interface 150 may also output a command or data received from other element(s) of the electronic device 101 to a user or another external device.

The display module 160 may include, for example, a Liquid Crystal Display (LCD), a Light Emitting Diode (LED) display, an Organic Light Emitting Diode (OLED) display, a MicroElectroMechanical System (MEMS) display, or an electronic paper display. The display module 160 may display various contents (e.g., a text, an image, video, an icon, or a symbol) to users. The display module 160 may include a touch screen, and receives a touch, a gesture, proximity, or a hovering input, for example, by using an electronic pen or a part of a body of a user.

The communication module 170 sets up communication, for example, between the electronic device 101 and an external device (e.g., a first external electronic device 102, a second external electronic device 104, or a server 106). For example, the communication module 170 is connected to a network 162 through wireless or wired communication to communicate with the external device (e.g., the second external electronic device 104 or the server 106).

Herein, the first external electronic device 102 may be a beacon. The first external electronic device 102 may send a beacon signal 164 at preset time intervals. The first external electronic device 102 may send the beacon signal 164 according to various communication protocols such as Bluetooth, Wireless Fidelity (WiFi), ANT, and the like.

The wireless communication may use, as a cellular communication protocol, for example, at least one of long-term evolution (LTE), LTE-advanced (LTE-A), code division multiple access (CDMA), wideband CDMA (WCDMA), a universal mobile telecommunication system (UMTS), wireless broadband (WiBro), or global system for mobile communications (GSM)). The wired communication may include, for example, at least one of a universal serial bus (USB), a high definition multimedia interface (HDMI), a recommended standard (RS)-2032, and a plain old telephone service (POTS). The network 162 may include a telecommunications network, for example, at least one of a computer network (e.g., a local area network (LAN) or a wide area network (WAN)), the Internet, and a telephone network.

Each of the first external electronic device 102 and the second external electronic device 104 may be a device of the same type as or a different type than the electronic device 101. According to an embodiment of the present disclosure, the server 106 may include a group of one or more servers. According to various embodiments, all or some of operations performed in the electronic device 101 may be performed in another electronic device or a plurality of electronic devices (e.g., the electronic devices 102 and 104 or the server 106). According to an embodiment of the present disclosure, when the electronic device 101 has to perform a function or a service automatically or at the request, the electronic device 101 may request another device (e.g., the electronic devices 102 and 104 or the server 106) to perform at least some functions associated with the function or the service instead of or in addition to executing the function or the service. The another electronic device (e.g., the electronic devices 102 and 104 or the server 106) may perform the requested function or an additional function and delivers the result to the electronic device 101. The electronic device 101 provides the received result or provides the requested function or service by processing the received result. To this end, for example, cloud computing, distributed computing, or client-server computing may be used.

According to an embodiment of the present disclosure, the server 106 performs at least one of operations implemented in the electronic device 101 to support driving of the electronic device 101. For example, the server 106 may support the processor 120 implemented in the electronic device 101. The server 106 may include at least one element of the processor 120 to perform (or substitute for) at least one of operations implemented by the processor 120.

The processor 120 processes at least a part of information obtained from other elements (for example, at least one of the memory 130, the I/O interface 150, the display module 160, the communication module 170, and so forth), and provides the obtained information part to the user in various ways. For example, the processor 120 may control at least some functions of the electronic device 101 so that the electronic device 101 interworks with another electronic device (e.g., the electronic device 102 or 104 or the server 106). The processor 120 may be integrated into the communication module 170. According to an embodiment of the present disclosure, at least an element of the processor 120 may be included in the server 106, and at least one operations implemented in the processor 120 may be supported by the server 106.

The communication module 170 according to various embodiments of the present disclosure receives a signal including information associated with a media device (e.g., state information of the media device, device information of the media device, etc.). The media device may be a device that provides audio and/or video contents. The media device broadcasts a signal including information associated with the media device (e.g., state information of the media device, device information of the media device, etc.) through short-range wireless communication (e.g., Bluetooth, WiFi, ANT, or the like). According to an embodiment of the present disclosure, the media device sends the signal to the electronic device 101 through wireless communication at the request of the electronic device 101.

According to an embodiment of the present disclosure, the information associated with the media device may include at least one of information regarding a configuration state of the media device, information regarding an operation state of the media device, and device information regarding the media device.

For example, the information regarding the configuration state of the media device may include whether the media device is in an initial configuration state where configuration has not been performed, whether configuration has been initialized by re-configuring the media device, and whether configuration has been performed by the electronic device 101. The information regarding the operation state of the media device may include information indicating whether the media device is currently in a turn-on state or in a turn-off state. The device information regarding the media device may include a device name of the media device and capability information regarding the media device. The state information regarding the media device may include any suitable type of information that needs to be provided for reception of configuration information available for configuring the media device.

The processor 120 according to various embodiments of the present disclosure obtains configuration information available for configuring the media device, based on the received signal. The processor 120 obtains the configuration information available for configuring the media device among at least one configuration information stored in the memory 130 of the electronic device 101.

The processor 120 according to various embodiments of the present disclosure transmits the obtained configuration information to the media device if the configuration information is obtained. The media device configures a driving environment for driving the media device based on the received configuration information.

In an embodiment of the present disclosure, the configuration information may include at least one of language configuration information (e.g., a language configuration setting), audio configuration information (e.g., an audio configuration setting), video configuration information (e.g., a video configuration setting), network configuration information (e.g., a network configuration setting), contents area configuration information (e.g., a contents area configuration setting), and account configuration information (e.g., an account configuration setting).

For example, the language configuration information may be configuration information regarding a language provided by the media device, and the audio configuration information and the video configuration information may be configuration information used to provide audio and video contents provided by the media device. The network configuration information may be configuration information used to configure a network environment of the media device, and the contents area configuration information may be configuration information used to select, according to an area, contents to be provided. The account configuration information may be configuration information regarding an account registered in a server for interworking with another electronic device.

The configuration information is merely an example for description, and is not limited thereto. The configuration information may include configuration information available for configuring the media device. A type of the configuration information may be preset according to the media device or may be set using a type of configuration information used for configuring the electronic device 101.

In an embodiment of the present disclosure, the processor 120 may control the communication module 170 to transmit configuration information used to configure the electronic device 101 to the media device, if the configuration information available for configuring the media device is not obtained in the memory 130. The media device may perform configuration using the configuration information used to configure the electronic device 101. In this way, the media device may perform configuration by using configuration information that is already in use by the user of the electronic device 101.

In an embodiment of the present disclosure, the processor 120 determines first configuration information that is previously used to configure the media device among at least one configuration information included in the electronic device 101, based on the received signal. For example, the processor 120 may determine whether the same configuration information as the configuration information used to configure the media device exists among the at least one configuration information stored in the memory 130.

In an embodiment of the present disclosure, if the first configuration information is determined, the processor 120 may control the communication module 170 to transmit the first configuration information to the media device. For example, if configuration information which has been used in an existing configuration process of the media device is included in the memory 130, the processor 120 controls the communication module 170 to transmit the first configuration information to the media device. In this way, the media device may perform configuration to the same configuration state as an existing configuration state based on the first configuration information used in the existing configuration process.

In an embodiment of the present disclosure, if the first configuration information is not determined, the processor 120 determines second configuration information related to the media device among at least one configuration information included in the memory 130. The second configuration information may be configuration information that is at least partially similar to the first configuration information that is previously used to configure the media device. For example, the second configuration information may be configuration information used in a media device that is a previous version model of the media device and is of the same manufacturer as the media device.

In an embodiment of the present disclosure, if the second configuration information is determined, the processor 120 controls the communication module 170 to transmit the second configuration information and the configuration information of the electronic device 101 to the media device. For example, since the second configuration information is not the same as the first configuration information, the processor 120 may control the communication module 170 to transmit the configuration information used to configure the electronic device, together with the second configuration information. The media device may perform configuration with respect to a part, which has not been configured using the second configuration information, by using the configuration information used to configure the electronic device 101.

In an embodiment of the present disclosure, if the second configuration information is not determined, the processor 120 controls the communication module 170 to send a request for at least one of the first configuration information and the second configuration information to the server. If either the first configuration information or the second configuration information is not determined among the at least one configuration information included in the memory 130, the processor 120 sends a request for at least one of the first configuration information and the second configuration information to the server. The server may include configuration information regarding various devices, and may include configuration information regarding devices registered by the user in association with a user's account.

In an embodiment of the present disclosure, if the first configuration information is received from the server, the processor 120 controls the communication module 170 to transmit the first configuration information to the media device. If the second configuration information is received from the server, the processor 120 controls the communication module 170 to transmit the second configuration information and the configuration information used to configure the electronic device to the media device.

In an embodiment of the present disclosure, if failing to receive the first configuration information and the second configuration information from the server, the processor 120 controls the communication module 170 to transmit the configuration information used to configure the electronic device to the media device.

In an embodiment of the present disclosure, the processor 120 controls the communication module 170 to transmit at least one information obtained in the electronic device 101 to the media device. For example, the processor 120 may control the communication module 170 to transmit information obtained by using at least one sensor included in the electronic device 101 to the media device. The information obtained in the electronic device 101 may also be used in a configuration process of the media device.

In an embodiment of the present disclosure, the at least one information obtained in the electronic device 101 may include at least one of screen configuration information, font configuration information, voice guide configuration information, and location information of the electronic device 101. However, the foregoing at least one information is merely an example for description, and is not limited thereto. The at least one information may include configuration information used in a configuration process or a detailed configuration process for driving of the media device.

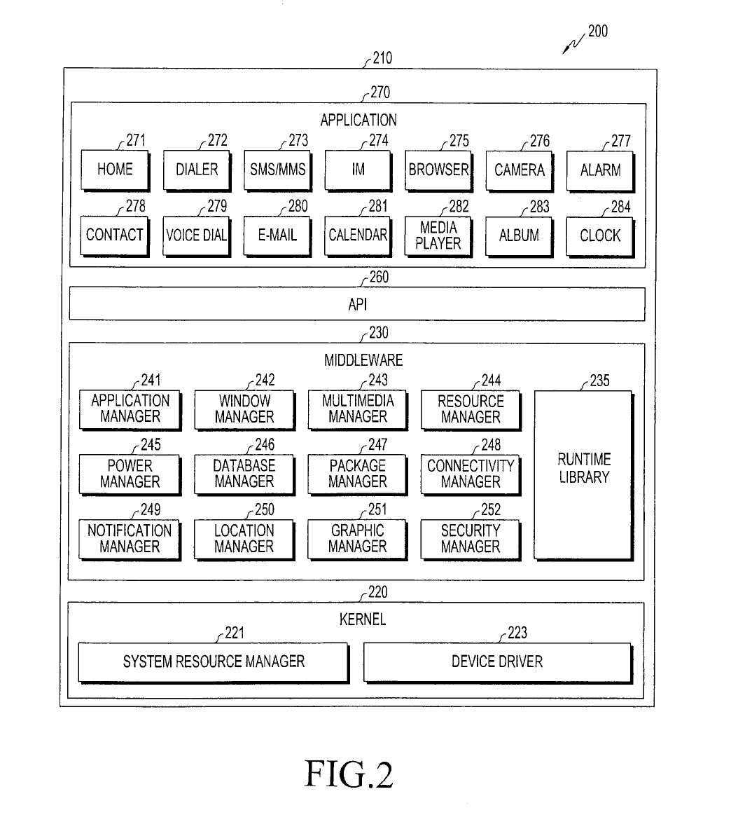

FIG. 2 is a block diagram 200 of an example of a programming module 210, according to an embodiment of the present disclosure. According to an embodiment of the present disclosure, the programming module 210 (e.g., the program 140) may include an OS for controlling resources associated with an electronic device (e.g., the electronic device 101) and/or various applications executed on the OS. The OS may include Android, iOS, Windows, Symbian, Tizen, or Bada.

The programming module 210 may include a kernel 220, a middleware 230, an application programming interface (API) 260, and/or an application 270. At least a part of the programming module 210 may be preloaded on an electronic device or may be downloaded from a server (e.g., the server 106).

The kernel 220 (e.g., the kernel 141 of FIG. 1) may include a system resource manager 221 and/or a device driver 223. The system resource manager 221 may perform control, allocation, or retrieval of system resources. According to an embodiment, the system resource manager 221 may include a process management unit, a memory management unit, or a file system. The device driver 223 may include, for example, a display driver, a camera driver, a Bluetooth driver, a shared memory driver, a USB driver, a keypad driver, a WiFi driver, an audio driver, or an inter-process communication (IPC) driver.

The middleware 230 may provide functions that the application 270 commonly requires or provide various functions to the application 270 through the API 260 to allow the application 270 to efficiently use a limited system resource in an electronic device. According to an embodiment, the middleware 230 (e.g., the middleware 143) may include at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and a security manager 252.

The runtime library 235 may include a library module that a compiler uses to add a new function through a programming language while the application 270 is executed. The runtime library 235 performs functions relating to an I/O, memory management, or calculation operation.

The application manager 241 manages a lifecycle of at least one application among the applications 270. The window manager 242 manages a GUI resource using a screen. The multimedia manager 243 recognizes a format necessary for playing various media files and performs encoding or decoding on a media file by using a codec appropriate for a corresponding format. The resource manager 244 manages a resource such as source code, memory, or storage space of at least one application among the applications 270.

The power manager 245 manages a battery or power in operation with a basic input/output system (BIOS) and provides power information necessary for an operation of the electronic device. The database manager 246 performs a management operation to generate, search or change a database used for at least one application among the applications 270. The package manager 247 manages the installation or update of an application distributed in a package file format.

The connectivity manager 248 manages a wireless connection such as a WiFi or Bluetooth connection. The notification manager 249 displays or notifies events such as arrival messages, appointments, and proximity alerts in a manner that is not disruptive to a user. The location manager 250 manages location information of an electronic device. The graphic manager 251 manages a graphic effect to be provided to a user or a user interface (UI) related thereto. The security manager 252 provides a general security function necessary for system security or user authentication. According to an embodiment of the present disclosure, when an electronic device (e.g., the electronic device 101) has a call function, the middleware 230 may further include a telephony manager for managing a voice or video call function of the electronic device.

The middleware 230 may include a middleware module forming a combination of various functions of the above-mentioned internal elements. The middleware 230 may provide modules specified according to types of OS so as to provide distinctive functions. Additionally, the middleware 230 may delete some existing elements or add new elements dynamically.

The API 260 (e.g., the API 145) may be provided as a set of API programming functions with a different configuration according to the OS. In the case of Android or iOS, for example, one API set may be provided by each platform, and in the case of Tizen, two or more API sets may be provided.

The application 270 (e.g., the application program 147) may include one or more applications capable of providing a function, for example, a home application 271, a dialer application 272, a short messaging service/multimedia messaging service (SMS/MMS) application 273, an instant message (IM) application 274, a browser application 275, a camera application 276, an alarm application 277, a contact application 278, a voice dial application 279, an e-mail application 280, a calendar application 281, a media player application 282, an album application 283, a clock application 284, a healthcare application (e.g., an application for measuring an exercise amount or a blood sugar), or an environment information providing application (e.g., an application for providing air pressure, humidity, or temperature information).

According to an embodiment of the present disclosure, the application 270 may include an application (hereinafter, an “information exchange application” for convenience) supporting information exchange between the electronic device (e.g., the electronic device 101) and an external electronic device (e.g., the electronic device 102 or 104). The information exchange application may include, for example, a notification relay application for transferring specific information to the external electronic device or a device management application for managing the external electronic device.

For example, the notification relay application may include a function for transferring notification information generated in another application (e.g., an SMS/MMS application, an e-mail application, a healthcare application, or an environment information application) of the electronic device to an external electronic device (e.g., the electronic device 102 or 104). The notification relay application may receive notification information from an external electronic device to provide the same to a user. The device management application may manage (e.g., install, remove, or update) at least one function (e.g., turn on/turn off of an external electronic device 102 or 104 itself (or a part thereof) or control of brightness (or resolution) of a display, a service provided by an application operating in an external electronic device (e.g., the electronic device) or provided by the external electronic device (e.g., a call service or a message service).

According to an embodiment, the application 270 may include an application (e.g., a healthcare application) designated according to an attribute of the external electronic device (e.g., a type of the electronic device being mobile medical equipment as the attribute of the electronic device). According to an embodiment, the application 270 may include an application received from the external electronic device (e.g., the server 106 or the electronic device 102 or 104). According to an embodiment, the application 270 may include a preloaded application or a third party application that may be downloaded from the server. Names of elements of the programming module 210 according to the illustrated embodiment may vary depending on a type of an OS.

According to various embodiments, at least a part of the programming module 210 may be implemented by software, firmware, hardware, or a combination of at least two of them. The at least a part of the programming module 210 may be implemented (e.g., executed) by a processor (e.g., the AP 210). The at least a part of the programming module 210 may include a module, a program, a routine, sets of instructions, or a process for performing one or more functions.

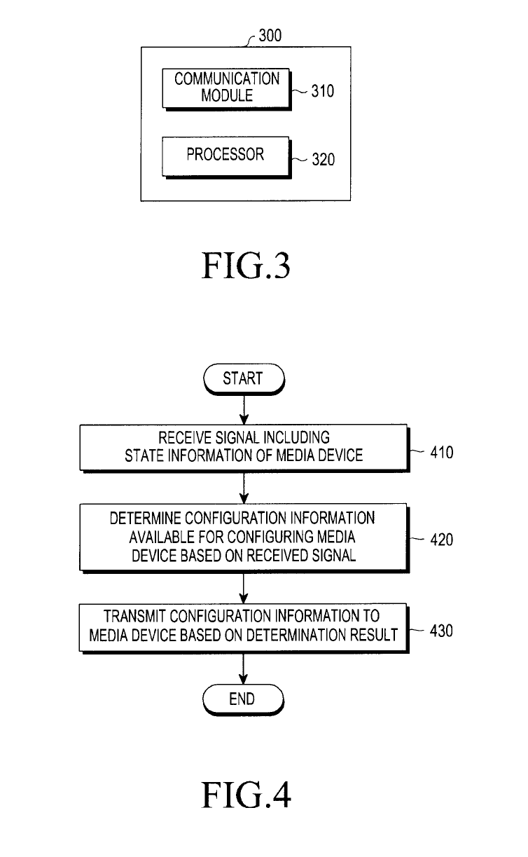

FIG. 3 is a block diagram of an example of a media device 300, according to an embodiment of the present disclosure.

The media device 300 according to various embodiments of the present disclosure may include a communication module 310 and a processor 320.

The communication module 310 according to various embodiments of the present disclosure broadcasts a signal including information associated with the media device 300 (e.g., state information of the media device, device information of the media device, etc.). The signal may be broadcast through short-range wireless communications (e.g., Bluetooth, NFC, etc.). The communication module 310 may continue to broadcast the signal even when the media device 300 is turned off.

In an embodiment of the present disclosure, the information associated with the media device 300 may include at least one of information identifying the configuration state of the media device 300, information identifying the operation state of the media device 300, and device information identifying the media device 300.

The communication module 310 according to various embodiments of the present disclosure may receive configuration information from the electronic device 101. The electronic device 101 transmits to the media device 300 at least one of first configuration information being previously used to configure the media device 300, second configuration information associated with the media device 300, and the configuration information used to configure the electronic device 101.

In an embodiment of the present disclosure, the configuration information may include at least one of language configuration information (e.g., a language configuration setting that specifies a choice of language to be used), audio configuration information (e.g., an audio configuration setting, such as one that specifies volume level, bass level, treble level, etc.), video configuration information (e.g., a video configuration setting, such as one that specifies screen brightness), network configuration information (e.g., a network configuration setting that identifies a router to be used and/or authentication for accessing the author), contents area configuration information (e.g., one or more configuration settings that identify a local or remote storage location from where content can be retrieved or streamed), and account configuration information (e.g., an account configuration setting, such as an account number, password, and/or user name that permits the media device 300 to log into a particular account and/or use a service associated with the account).

The processor 320 according to various embodiments of the present disclosure may determine configuration information available for configuring the media device 300 among the configuration information received via the communication module 310. Since the received configuration information may be incompatible with the media device 300, the processor 320 may determine whether the received configuration information is capable of being used for configuring the media device 300.

The processor 320 according to various embodiments of the present disclosure may configure the media device 300 based on the configuration information. In this way, the processor 320 may control configuration to be automatically performed by the media device 300, without a need for configuration to be manually performed by the user in the configuration process.

In an embodiment of the present disclosure, the processor 320 may detect whether the received configuration information is compatible with the media device 300 by comparing configuration information pre-stored in the memory of the media device 300 with the received configuration information. The processor 320 may determine that the configuration information is capable of being used for configuring the media device 300 based on the pre-stored configuration information matching the received configuration information. In this way, the processor 320 selectively uses the received configuration information to configure the media device 300.

In an embodiment of the present disclosure, when at least a portion of the pre-stored configuration information does not match the received configuration information, the processor 320 controls display of the media device 300 to display a user interface for manually specifying one or more configuration settings that cannot be automatically determined based on the received configuration information. For example, if there exists the configuration information that does not correspond to the received configuration information among the configuration information of the media device 300, the configuration of the media device 300 may not be completed. Thus, to complete configuration of the media device 300, the processor 320 displays the user interface for the configuration information that does not correspond to the received configuration information. By doing so, the processor 320 induces the user to manually configure the media device 300.

In an embodiment of the present disclosure, the communication module 310 receives at least one information obtained in the electronic device 101. The at least one information obtained in the electronic device 101 is also available for configuring the media device 300, such that the communication module 310 may receive the at least one information. In an embodiment of the present disclosure, the processor 320 identifies portions of the received configuration information that are capable of being used for configuring the media device 300. The processor 320 configures the media device 300 based on the identified portions. By doing so, the processor 320 selectively uses the received at least one information to configure the media device 300.

In an embodiment of the present disclosure, the processor 320 compares the configuration information of the media device 300 (e.g., configuration information that is pre-stored on the media device 300) with the received configuration information. The processor 320 determines whether any of the configuration information is capable of being used for configuring the media device 300 based on the comparison result.

FIG. 4 is a flowchart of an example of a process, according to an embodiment of the present disclosure.

In operation 410, the electronic device 101 receives a signal including information associated with the media device 300. The media device 300 broadcasts the signal through short-range wireless communication or sends the signal to the electronic device 101 through wireless communication at the request of the electronic device 101.

Prior to operation 410, a discovery process for short-range communication between the electronic device 101 and the media device 300 may be performed. The electronic device 101 may perform a process of continuously scanning a connectable device through short-range communication. The media device 300 may be discovered by the electronic device 101 as a device capable of short-range communication through the scanning process. Through this process, the electronic device 101 may store information available for short-range communication with the media device 300. The discovery process for short-range communication may also be performed in the media device 300.

In operation 420, the electronic device 101 determines (e.g., obtains) configuration information available for configuring the media device 300 based on the received signal. The electronic device 101 determines configuration information available for configuring the media device 300 among at least one configuration information. The configuration information may include configuration information available for configuring the media device 300. The at least one configuration information may be stored in the memory of the electronic device 101 or on the server. If the at least one configuration information is included in the stored on the server, the electronic device 101 sends a request for the at least one configuration information upon receiving the signal and receives the at least one configuration information from the server. Stated succinctly, in some implementations, the electronic device 101 may obtain configuration information available for configuring the media device 300 from a configuration information database stored in the memory of the electronic device 101.

In an embodiment of the present disclosure, the electronic device 101 determines if the configuration information is stored in the memory of the electronic device 101, upon receiving the signal. If the configuration information is not available, the electronic device 101 sends a request for the configuration information to the server based on the signal.

In operation 430, the electronic device 101 transmits the configuration information to the media device 300. The electronic device 101 transmits to the media device 300 at least one of a first configuration information previously used to configure the media device 300, a second configuration information associated with the media device 300, and the configuration information used to configure the electronic device 101.

The media device 300 performs configuration based on the configuration information received from the electronic device 101, such that the media device 300 may automatically perform configuration without a need for the user to manually perform configuration.

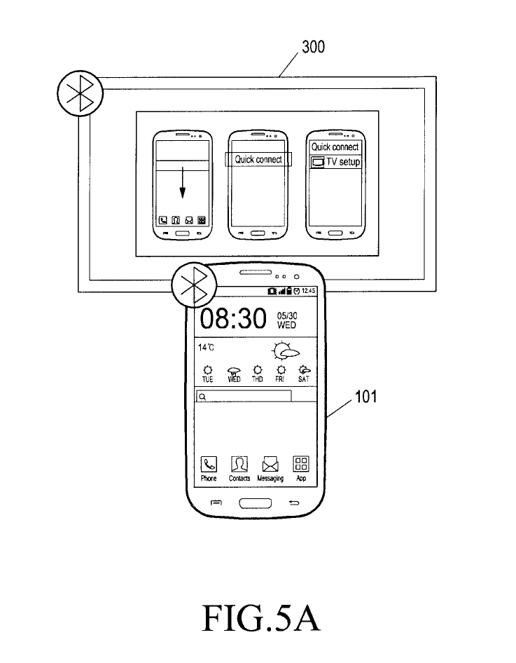

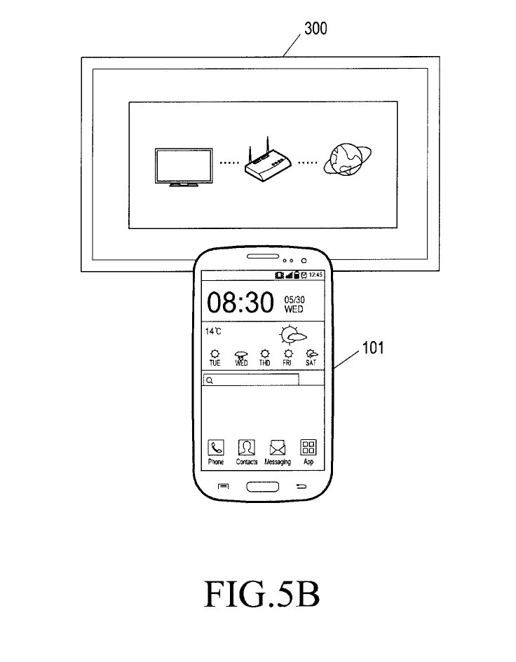

FIGS. 5A and 5B are diagrams of an example of a system, according to an embodiment of the present disclosure. More particularly, FIG. 5A illustrates an interface screen for guiding configuration of the media device 300 by using the electronic device 101, according to an embodiment of the present disclosure. As shown in FIG. 5A, the media device 300 guides a configuration process using the electronic device 101 for the user prior to execution of the configuration process and induces the user to perform the configuration process by using the electronic device 101.

FIG. 5B illustrates an interface screen that is displayed by the media device 300 when the media device automatically configures itself based on configuration information received from the electronic device 101. For example, the media device 300 may perform configuration including language configuration, network configuration, contents area configuration, and account information configuration used in an interface of the electronic device 101 based on the signal received from the electronic device 101. In this way, the media device 300 may automatically perform configuration based on the received configuration information.

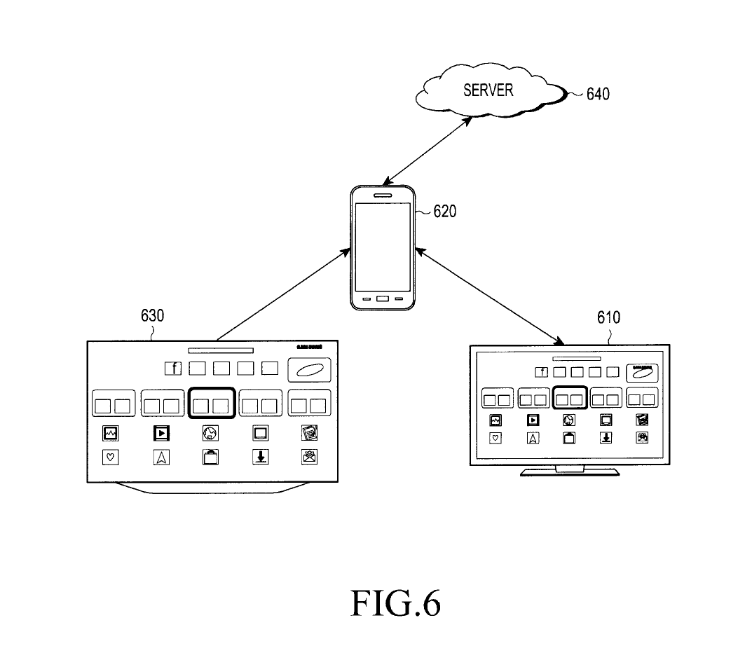

FIG. 6 is a diagram of an example of a system, according to an embodiment of the present disclosure.

In an embodiment of the present disclosure, a first media device 610 is configured based on configuration information received from a smartphone 620. The smartphone 620 obtains the configuration information available for configuring the first media device 610 among at least one configuration information included in the smartphone 620.

In an embodiment of the present disclosure, the smartphone 620 may obtain a first configuration information previously used to configure the first media device 610 among the at least one configuration information. The smartphone 620 determines second configuration information associated with the first media device 610 among the at least one configuration information. For example, the configuration information previously configured in the first media device 610 may include one or more past configuration settings of the media device 610 (e.g., configuration settings previously used by the electronic device).

Additionally or alternatively, the smartphone 620 may obtain a second configuration information. The second configuration information may be configuration information being associated second media device 630. The second configuration information may include one or more past or current settings of the second media device 630 (e.g., current screen brightness of the second media devices, one or more settings for accounts which the second media device is configured to access, network settings of the media device, etc.) In some embodiments, the smartphone 620 may identify the second media device (630) and/or the configuration information associated with the second media device 630 based on the second devices 630 possessing a characteristic that matches a characteristic of the first media device that is identified in state information transmitted by the media device 610. For example, the second media device 630 may be a media device of a previous version model of the first media device 610 or may be a media device manufactured by the same manufacturer as that of the first media device 610. The second media device 630 may be a media device including configuration information corresponding to at least a part of the configuration information of the first media device 610.

In an embodiment of the present disclosure, if the configuration information available for configuring the first media device 610 is cannot be obtained or otherwise determined, the smartphone 620 transmits the configuration information of the smartphone 620 to the first media device 610. For example, the configuration information of the smartphone may be retrieved in response to the smartphone 620 failing to identify a past configuration setting of the first media device 620 and/or another device possessing a characteristic that matches a characteristic of the smartphone. The first media device 610 performs configuration using the configuration information of the smartphone 620. The smartphone 620 also transmits at least one information obtained in the smartphone 620 to the first media device 610. The first media device 610 performs configuration the at least one information obtained in the smartphone 620.

The first media device 610 may perform configuration by selectively using the configuration information received from the smartphone 620. For example, the first media device 610 may perform configuration merely with the first configuration information, if receiving the first configuration information. However, if the first media device 610 receives at least one of the second configuration information and the configuration information of the smartphone 620, the first media device 610 may not use either the second configuration information or the configuration information of the smartphone 620 for configuration.

In this case, the first media device 610 selects necessary configuration information between the second configuration information and the configuration information of the smartphone 620 and transitions into a manual configuration mode. When in the manual configuration mode, the first media device 610 may display a user interface for that permits the user to manually input the values for one or more configuration settings that cannot be set based on the received configuration information.

In some implementations, the at least one configuration information may be stored in the smartphone 620 or a server 640. If the at least one configuration information is included in the server 640, the smartphone 620 sends a request for the at least one configuration information to the server 640 to determine configuration information available for configuring the first media device 610. The server 640 transmits the at least one configuration information to the smartphone 620 in response to the request.

In an embodiment of the present disclosure, the smartphone 620 sends a request for the first configuration information being previously configured in the first media device 610 to the server 640 based on the signal received from the first media device 610. The server 640 may include configuration information being previously configured in each media device for at least one media devices. The server 640 determines the first configuration information (e.g., information including a configuration setting of the first media device 610 that was used in the past by the first media device 610) based on the request for the first configuration information. If the server 640 cannot determine the first configuration information, the server 640 may determine whether second configuration information associated with the first media device 610 exists and transmit the second configuration information to the smartphone 620. As noted above, the second configuration information may include a configuration setting associated with another media device that possesses a characteristic that matches a characteristic of the media device 610.

In an embodiment of the present disclosure, if failing to receive the first configuration information and the second configuration information from the server 640, the smartphone 620 transmits the configuration information of the smartphone 620 to the first media device 610.

As such, the first media device 610 may receive configuration information of at least one of the smartphone 620 and the second media device 630 to perform configuration. In this way, configuration may be performed based on the user's preference for various aspects of the operation of the media device 610, such as screen color, screen contrast, font size, and voice guide of the smartphone 620, may be applied to the first media device 610.

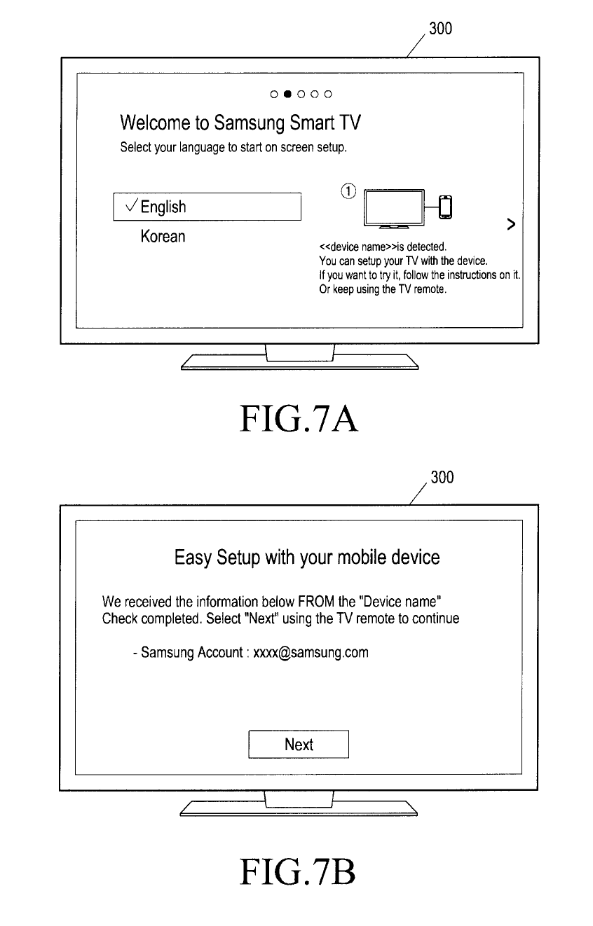

FIGS. 7A and 7B illustrate an interface screen for configuring the media device 300, according to an embodiment of the present disclosure.

FIG. 7A illustrates an interface screen for specifying a language configuration setting of the media device 300. As illustrated, if the user directly configures the media device 300, the user has to inconveniently perform each operation of a configuration process for the media device 300 by using an input device of the media device 300. If the input device of the media device 300 is limited (like, for example, a remote controller), inconvenience in the configuration process for the media device 300 may be increased.

FIG. 7B illustrates an interface screen for specifying an account configuration setting of the media device 300. As shown in FIG. 7B, if the media device 300 is configured using the electronic device 101, the media device 300 may be configured merely with an input for approving configuration of the media device 300 through the electronic device 101. In this way, if the media device 300 is configured through the electronic device 101, the media device 300 may be easily configured even with a limited input device of the media device 300. Moreover, by performing configuration of the media device 300 using existing configuration information or the configuration information of the electronic device 101, configuration information based on user's preference and user's personal characteristics may be applied to the media device 300.

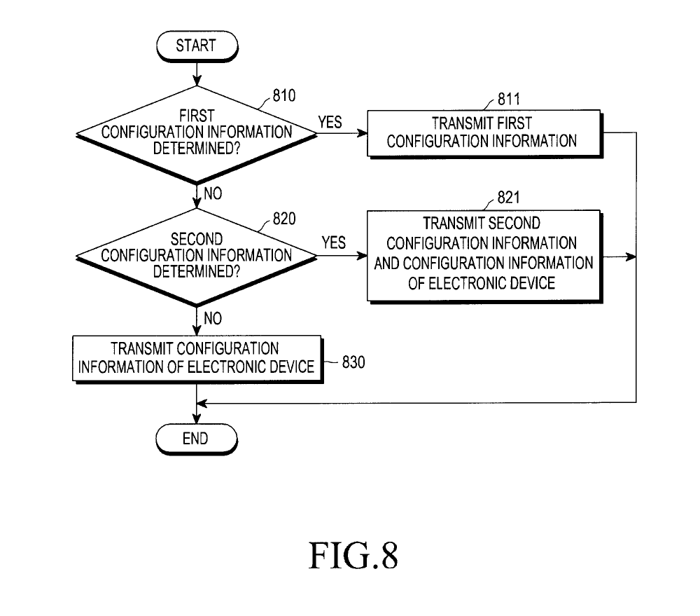

FIG. 8 is a flowchart of an example of a process, according to an embodiment of the present disclosure.

In operation 810, the electronic device 101 determines whether a first configuration information previously used to configure the media device 300 is stored in the memory of the electronic device 101, based on a signal received from the media device 300. If the at least one configuration information is included in a server, the electronic device 101 sends a request for the at least one configuration information to the server.

For example, the electronic device 101 may determine the first configuration information by searching a database for configuration information that is associated with the media device 300 (e.g., a local database or one stored on a remote server). The electronic device 101 determines a list of configuration information items (e.g., configuration settings) requested by the media device 300, and retrieves from the first database, as the first configuration information, one or more of the configuration settings identified in the list. As noted above, in some implementations, the one or more configuration settings may be past configuration settings of the media device (e.g., configuration settings the electronic device has used previously), and or any other suitable type of configuration settings.

In operation 811, if the first configuration information is determined, the electronic device 101 transmits the first configuration information to the media device 300. Since the first configuration information corresponds to the configuration information being previously configured in the media device 300, the media device 300 may perform configuration merely with the first configuration information.

In operation 820, if the first configuration information is not determined (e.g., if the electronic device cannot obtain the first configuration information), the electronic device 101 determines second configuration information associated with the media device 300 among the at least one configuration information. The second configuration information corresponds to at least one configuration information of a media device that possesses a characteristic that matches a characteristic of the media device 300.

For example, the electronic device 101 may determine (e.g., obtain), as the second configuration information, configuration information corresponding to a media device that is an earlier model in the same product line as the media device 300 or a media device of the same manufacturer as the media device 300, based on the device information of the media device 300 among the at least one configuration information. The electronic device 101 may also determine the list of the configuration information requested by the media device 300 and retrieve, from the database, one or more configuration settings that match those in the list.

In operation 821, if the second configuration information is determined, the electronic device 101 transmits the second configuration information and the configuration information of the electronic device 101 to the media device 300. Since the second configuration information at least partially corresponds to the configuration information being previously configured in the media device 300, the electronic device 101 transmits the configuration information of the electronic device 101, together with the second configuration information, to the media device 300.

In this case, the electronic device 101 may perform configuration by selecting necessary configuration information between the second configuration information and the configuration information of the electronic device 101. By providing a user interface, the media device 300 may manually input the values of one or more configuration settings that cannot be automatically set based on received configuration information.

In operation 830, if the second configuration information is not determined, the electronic device 101 transmits one or more of its own configuration settings (e.g., configuration settings the electronic device 101 is currently operating in accordance with) to the media device 300. If the second configuration information is not determined, the electronic device 101 determines that configuration information available for configuring the media device 300 is not determined. At least one corresponding configuration information may exist in the electronic device 101 and the media device 300, such that the electronic device 101 may transmit the configuration information thereof to the media device 300.

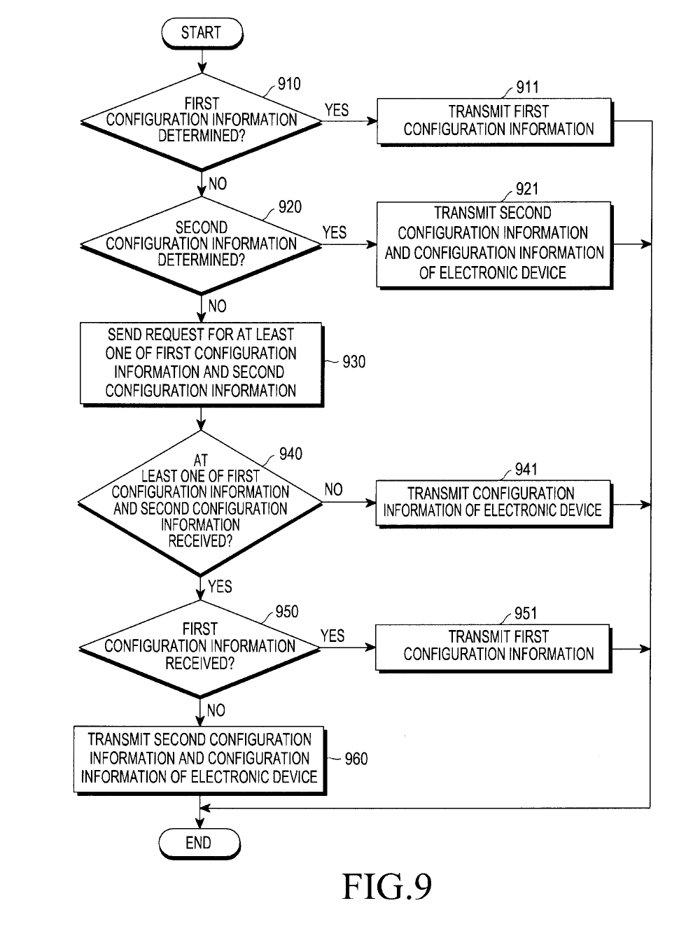

FIG. 9 is a flowchart of an example of a process, according to an embodiment of the present disclosure.

In operation 910, the electronic device 101 determines first configuration information being previously configured in the media device 300 among at least one configuration information included in the memory device 101, based on a signal received from the media device 300.

In operation 911, if the first configuration information is determined, the electronic device 101 transmits the first configuration information to the media device 300. The first information may include one or more past configuration settings of the media device (i.e., configuration settings that the media device has previously used for its operation). Additionally or alternatively, the information previously configured may include any suitable type of configuration information that is associated with the media device. The first information may be identified by performing a database search based on state information that is received from the media device 300.

In operation 920, if the first configuration information is not determined, the electronic device 101 determines second configuration information associated with the media device 300 among the at least one configuration information. As noted above, the second configuration information may include a configuration setting associated with another media device that possesses a characteristic that matches a characteristic of the media device 300. The other media device may be associated with the media device 300 in any suitable manner. For example, the other media device may have the same manufacturer as the media device 300, be part of the same product line as the media device 300, etc.

In operation 921, the electronic device 101 transmits the second configuration information to the media device 300. In some implementations, along with the second information, the electronic device 101 may also transmit to the media device 300 configuration information of the electronic device 101. As noted above, the configuration information of the electronic device 101 may include one or more configuration settings that are currently being used by the electronic device 101. By way of example, those settings may identify one or more of a current screen brightness of the electronic device, a local network used by the electronic device 101 to connect to the Internet, etc.

In operation 930, if the second configuration information is not determined, the first electronic device sends a request for at least one of the first configuration information and the second configuration information to a server. The electronic device 101 may send a request for the entire at least one configuration information included in the server, or a request for at least one of the first configuration information and the second configuration information based on the received signal as in operation 930.

In operation 940, the electronic device 101 determines whether at least one of the first configuration information and the second configuration information has been received from the server.

In operation 941, if failing to receive the first configuration information and the second configuration information from the server, the electronic device 101 transmits only the configuration information of the electronic device 101 to the media device 300.

In operation 950, the electronic device 101 determines whether the first configuration information has been received from the server. The electronic device 101 determines whether the configuration information received from the server is the first configuration information.

In operation 951, if the first configuration information is received from the server, the electronic device 101 transmits the first configuration information to the media device 300.

In operation 960, if failing to receive the first configuration information from the server, the electronic device 101 transmits the second configuration information (provided that the second configuration information is received from the server) and the configuration information of the electronic device 101 to the media device 300. Since the electronic device 101 sends the request for at least one of the first configuration information and the second configuration information to the server, the electronic device 101 may determine the received configuration information as the second configuration information if the configuration information received from the server is not the first configuration information.

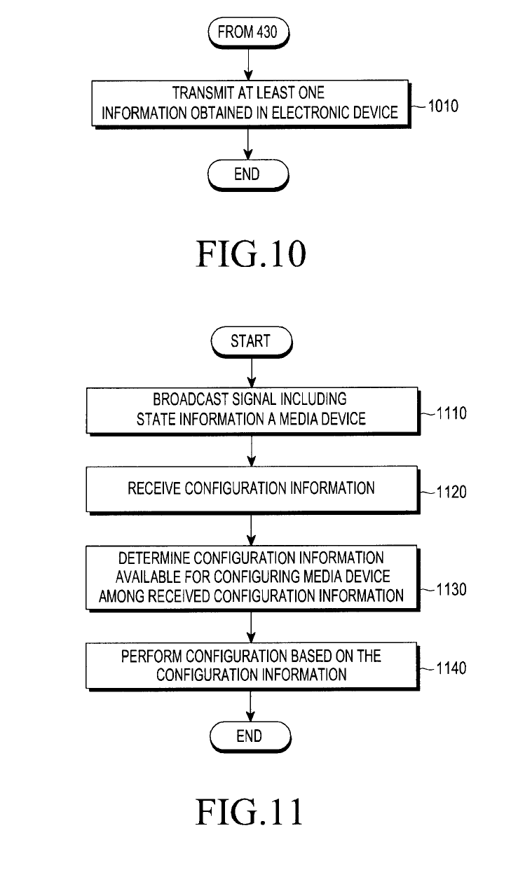

FIG. 10 is a flowchart of an example of a process, according to an embodiment of the present disclosure.

In operation 1010, the electronic device 101 transmits at least one information obtained by the electronic device 101 to the media device 300, as the configuration information. The media device 300 performs configuration through information obtained in the electronic device 101.

FIG. 11 is a flowchart of an example of a process, according to an embodiment of the present disclosure.

In operation 1110, the media device 300 broadcasts a signal including information associated with the media device 300. The media device 300 broadcasts the signal through short-range communication or transmits the signal to the electronic device 101 through wireless communication at the request of the electronic device 101. The signal including the state of the electronic device may identify one or more characteristics of the media device, such as a model of the media device, a manufacturer of the media device, a unique identifier corresponding to the media device, current operational state of the media device, and/or current configuration state of the media device.

In operation 1120, the media device 300 receives configuration information from the electronic device 101 that is transmitted in response to the signal. The media device 300 may receive from the electronic device 101 at least one of first configuration information being previously configured in the media device 300, second configuration information associated with the media device 300, and configuration information of the electronic device 101.

In operation 1130, the media device 300 determines configuration information available for configuring the media device 300 among the received configuration information. For example, the media device 300 detects whether the received configuration information is compatible with the media device 300. For example, the media device 300 may determine whether the configuration information follows a syntax supported by the electronic device, and/or includes all necessary values necessary for changing a particular configuration setting of the media device. The media device 300 may selectively use the received configuration information to perform configuration or change its configuration. Since the received configuration information may include information that is not available for configuring the media device 300, the media device 300 may determine whether the received configuration information is available for configuring the media device 300. For example, in instances in which the configuration information is partially incompatible with the media device 300, the media device 300 may identify at least one portion of the configuration information (e.g., one or more configuration settings) that is compatible with the media device 300 and/or another portion of the configuration information (e.g., one or more configuration settings) that is not compatible with the media device 300.

In operation 1140, the media device 300 performs configuration based on the determined configuration information. For example, if the media device 300 receives the first configuration information, the media device 300 may perform configuration merely with the first configuration information. If the media device 300 receives the second configuration information and the configuration information of the electronic device 101, the media device 300 may selectively use the second configuration information and the configuration information of the electronic device 101 for configuring the media device 300. If the received configuration is only partially compatible with the media device 300, the media device 300 may use only those portions of the configuration information that are compatible with the media device 300 for configuring the media device 300. Moreover, in some instances, the media device 300 may induce the user to perform configuration with respect to configuration information which has not been configured through the second configuration information and the configuration information of the electronic device 101 by providing a user interface.

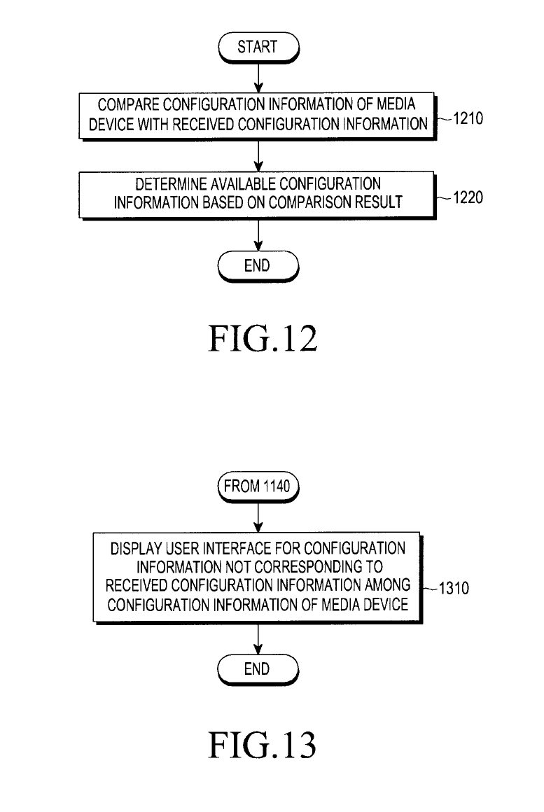

FIG. 12 is a flowchart of a method for determining configuration information available for configuration by a media device according to various embodiments of the present disclosure.

In operation 1210, the media device 300 compares configuration information pre-stored in the memory of the media device 300 with the received configuration information. The media device 300 may compare the configuration information of the media device 300 with the received configuration information to determine configuration information available for configuring the media device. For example, the media device 300 determines whether the received configuration information is compatible with the media device 300.

In operation 1220, the media device 300 determines the configuration information available for configuring the media device 300 based on the comparison result. For example, if the pre-stored configuration information of the media device 300 is determined to match the received configuration information, the determined configuration information may be used for configuring the media device 300.

FIG. 13 is a flowchart of an example of a process, according to an embodiment of the present disclosure.

In operation 1310, the media device 300 displays a user interface for configuration information that does not correspond to the received configuration information among the configuration information of the media device 300. For example, the media device 300 displays a user interface for manually configuring the media device 300. By providing the user interface, the media device 300 may induce the user to perform manually configure the media device 300 when automatic configuration (e.g., of a particular configuration setting) is not possible due to the received configuration information not matching the pre-stored configuration information. For example, if audio configuration information among the pre-stored configuration information of the media device 300 does not correspond to the received configuration information, the media device 300 displays a user interface for specifying different audio settings of the media device 300. The user may perform configuration with respect to the audio configuration information through the user interface for the audio configuration information.

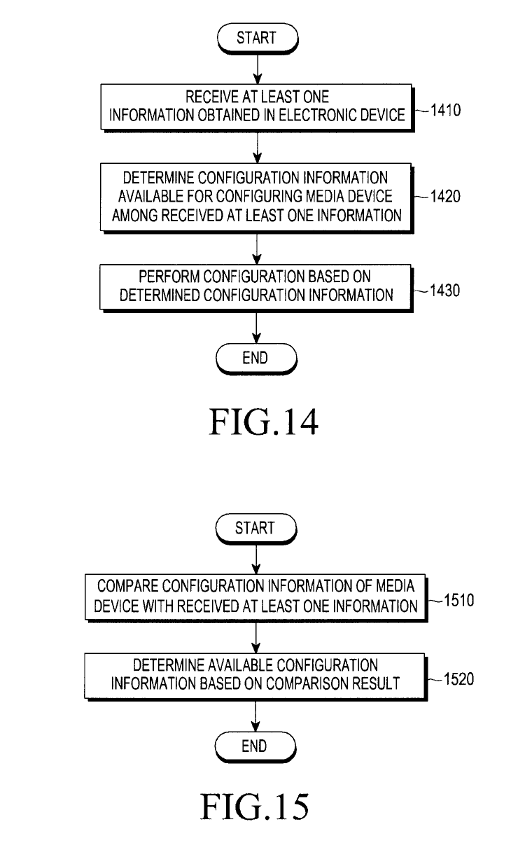

FIG. 14 is a flowchart of an example of a process, according to an embodiment of the present disclosure.

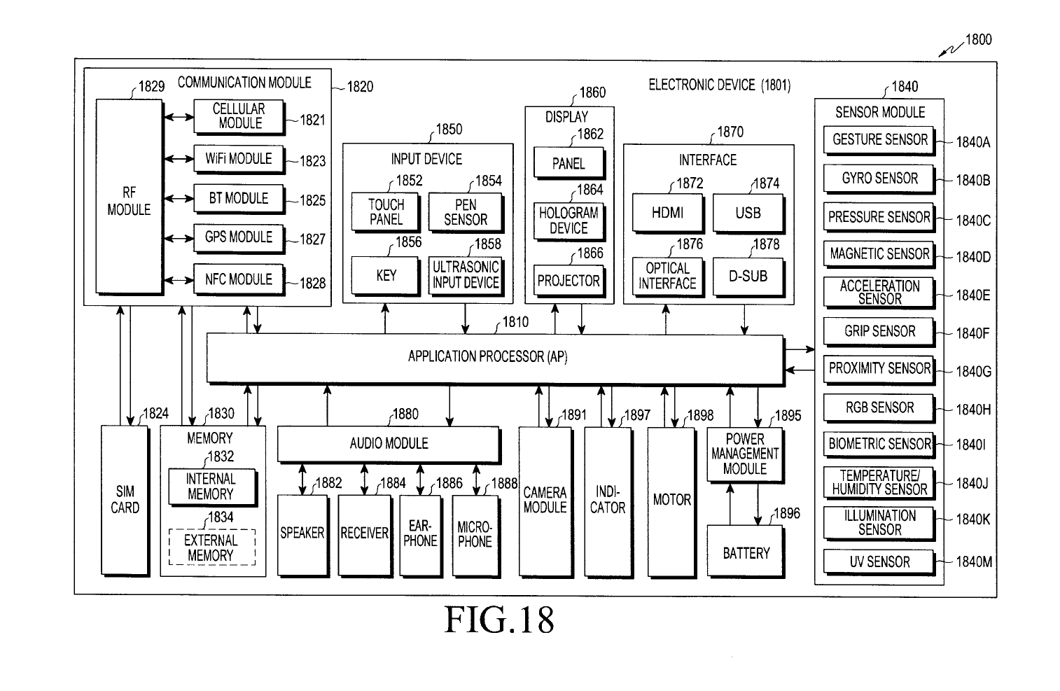

In operation 1410, the media device 300 receives at least one information obtained in the electronic device 101. For example, the at least one information obtained by at least one sensors of the electronic device 101 may also be used for configuring the media device 300. As illustrated in FIG. 18, the one or more sensors may include a GPS receiver, a touch panel, a microphone, and/or any of the sensors that are part of the sensor module 1840.

In operation 1420, the media device 300 determines configuration information available for configuring the media device 300 among the received at least one information. For example, the media device 300 determines whether the received at least one information is compatible with the media device 300. In instances in which the media device 300 may not be able to use all of the received information for configuration purposes, the electronic device may identify one or more portions of the configuration information that are usable for configuration purposes.

In operation 1430, the media device 300 performs configuration based on the determined configuration information. In some implementations, the media device 300 may use only those portions of the configuration information that are considered compatible with the media device 300.

FIG. 15 is a flowchart of an example of a process, according to an embodiment of the present disclosure.

In operation 1510, the media device 300 compares configuration information pre-stored in the memory of the media device 300 with the received at least one information. The media device 300 may compare the configuration information of the media device 300 with the received at least one information to determine configuration information available for configuring the media device 300.

In operation 1520, the media device 300 determines the available configuration information of the media device 300 based on the comparison result. For example, if a configuration information type corresponding to a configuration information type of the media device 300 is determined among the received information, the determined configuration information may be used for configuring the media device 300.

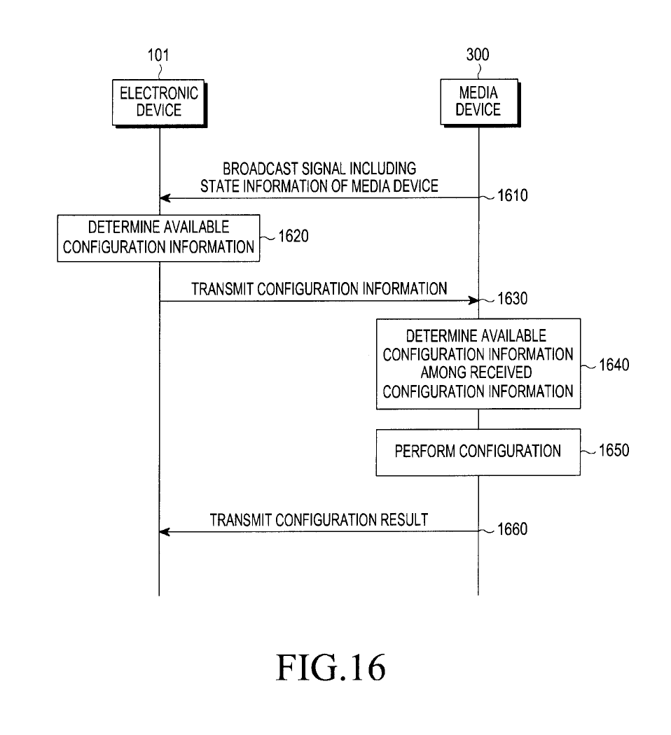

FIG. 16 is a sequence diagram of an example of a process, according to an embodiment of the present disclosure.

In operation 1610, the media device 300 broadcasts a signal including state information of the media device 300. The media device 300 may broadcast the signal through short-range communication, or send a signal to the electronic device 101 through wireless communication at the request of the electronic device 101. Prior to operation 1610, a discovery process for short-range communication between the electronic device 101 and the media device 300 may be performed.

In operation 1620, the electronic device 101 determines (e.g., obtains) configuration information available for configuring the media device 300 based on the received signal. The configuration information may include configuration information available for configuring the media device 300.

In operation 1630, the electronic device 101 transmits the determined (e.g., obtained) configuration information to the media device 300 if the configuration information is determined (e.g., obtained). The electronic device 101 may transmit at least one of first configuration information being previously configured in the media device 300, second configuration information associated with the media device 300, and configuration information of the electronic device 101 to the media device 300.

In operation 1640, the media device 300 determines the configuration information available for configuring the media device 300 among the received configuration information. For example, the media device 300 determines whether the configuration information is compatible with the media device. As noted above, the media device 300 may identify one or more portions of the received configuration information that are compatible with the media device 300.

In operation 1650, the media device 300 performs configuration with respect to the determined configuration information. For example, if the media device 300 receives the first configuration information, the media device 300 may perform configuration merely with the first configuration information. If the media device 300 receives the second configuration information and the configuration information of the electronic device 101, the media device 300 may selectively use the second configuration information and the configuration information of the electronic device 101 for configuration.

In operation 1660, the media device 300 transmits an indication of the configuration result to the electronic device 101. For example, the indication of the configuration result may identify one or more portions of the received configuration information (e.g., configuration settings) that are compatible with the media device 300. The electronic device 101 stores the received configuration result. In this way, if configuration needs to be performed as when the media device 300 is re-configured, the electronic device 101 may transmit configuration information based on the configuration result to the media device 300.

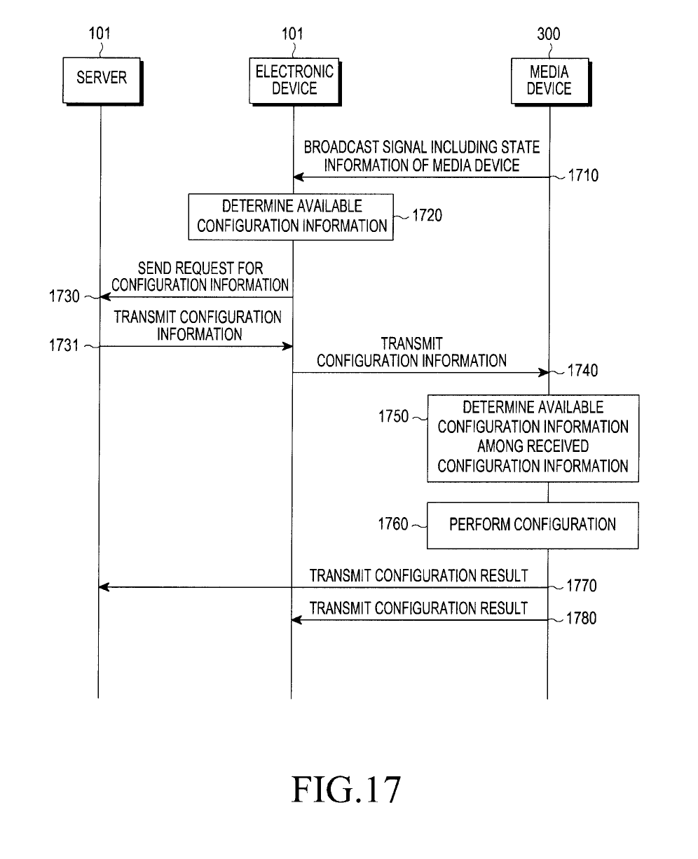

FIG. 17 is a sequence diagram of an example of a process, according to an embodiment of the present disclosure.

In operation 1710, the media device 300 broadcasts a signal including state information of the media device 300. The media device 300 may broadcast the signal through short-range communication.

In operation 1720, the electronic device 101 determines configuration information available for configuring the media device 300 based on the received signal. In some implementations, determining whether configuration information may include detecting whether the configuration information is available in the memory of the electronic device 101.

In operation 1730, the electronic device 101 sends a request for configuration information to a server 1700. In some implementations, the requests may be sent only when the electronic device 101 determines that the configuration information is not available in its memory. For example, the electronic device 101 may send a request for at least one of the first configuration information and the second configuration information to the server 1700.

In an embodiment of the present disclosure, if receiving the signal from the media device 300, the electronic device 101 may send a request for the available configuration information to the server 1700 without determining the available configuration information as in operation 1720.

In operation 1731, the server 1700 transmits configuration information to the electronic device 101. The server 1700 may transmit the available configuration information to the electronic device 101 in response to the request for the configuration information.

In an embodiment of the present disclosure, the server 1700 may transmit the entire at least one configuration information included in the server 1700 to the electronic device 101 in response to the request for the configuration information. In some implementations, the electronic device 101 may additionally determine whether the configuration information is compatible with the media device 300 and identify one or more portions of the configuration information that are compatible.

In operation 1740, the electronic device 101 transmits the received from the server 1700 to the media device 300. In some implementations, the electronic device 101 may transmit only those portions of the configuration information that are considered compatible.

In operation 1750, the media device 300 determines configuration information available for configuring the media device 300 among the received configuration information. For example, the media device 300 determines whether the configuration information is compatible with the media device. The media device 300 may identify and selectively use one or more portions of the configuration information (e.g., configuration settings) to perform configuration.

In operation 1760, the media device 300 performs configuration based on the determined configuration information. For example, if receiving the first configuration information, the media device 300 may perform configuration merely with the first configuration information. If receiving the second configuration information and the configuration information of the electronic device 101, the media device 300 may selectively use the second configuration information and the configuration information of the electronic device 101 for configuration.

In operation 1770, the media device 300 transmits the configuration result to the server 1700.

In operation 1780, the media device 300 transmits an indication of the configuration result to the electronic device 101. For example, the indication of the configuration result may identify one or more portions of the received configuration information (e.g., configuration settings) that are compatible with the media device 300. The electronic device 101 and the server 1700 may store the received configuration result. In this way, when re-configuration is needed like when the media device 300 is re-configured, the electronic device 101 and the server 1700 may transmit configuration information based on the configuration result to the media device 300.

According to an embodiment of the present disclosure, a method for transmitting configuration information to a media device by an electronic device includes receiving a signal comprising information associated with the media device, obtaining configuration information available for configuring the media device based on the received signal, and transmitting the obtained configuration information to the media device if the configuration information is obtained.

According to an embodiment of the present disclosure, the information associated with the media device comprises at least one of information regarding a configuration state of the media device, information regarding an operational state of the media device, and device information of the media device.

According to an embodiment of the present disclosure, the configuration information may include at least one of language configuration information, audio configuration information, video configuration information, network configuration information, contents area configuration information, and account configuration information.

According to an embodiment of the present disclosure, the method further comprises transmitting configuration information used to configure the electronic device to the media device, if the configuration information available for configuring the media device is not obtained.

According to an embodiment of the present disclosure, the obtaining the configuration information comprises determining first configuration information previously used to configure the media device among at least one configuration information stored in a memory of the electronic device, based on the received signal.

According to an embodiment of the present disclosure, the transmitting of the configuration information to the media device may include transmitting the first configuration information to the media device, if the first configuration information is determined.

According to an embodiment of the present disclosure, the obtaining the configuration information comprises, determining second configuration information associated with the media device among at least one configuration information stored in the memory, if the first configuration information is not determined.

According to an embodiment of the present disclosure, the transmitting of the configuration information to the media device may include transmitting the second configuration information and configuration information used to configure the electronic device to the media device, if the second configuration information is determined.

According to an embodiment of the present disclosure, the method may further include transmitting a request for at least one of the first configuration information and the second configuration information to a server, if the second configuration information is not determined.

According to an embodiment of the present disclosure, the method may further include transmitting the first configuration information to the media device, if the first configuration information is received from the server and transmitting the second configuration information and configuration information of the electronic device to the media device, if the second configuration information is received from the server.

According to an embodiment of the present disclosure, the method may further include transmitting at least one information obtained in the electronic device to the media device.

According to an embodiment of the present disclosure, the at least one information may further include at least one of screen configuration information, font configuration information, voice guide configuration information, and location information of the electronic device.

According to an embodiment of the present disclosure, an electronic device for transmitting configuration information to a media device includes a communication module configured to receive a signal comprising information associated with the media device and a processor configured to obtain configuration information available for configuring the media device based on the received signal and to transmit the obtained configuration information to the media device if the configuration information is obtained.

According to an embodiment of the present disclosure, the information associated with the media device comprises at least one of information regarding a configuration state of the media device, information regarding an operational state of the media device, and device information of the media device.

According to an embodiment of the present disclosure, the configuration information may include at least one of language configuration information, audio configuration information, video configuration information, network configuration information, contents area configuration information, and account information.

According to an embodiment of the present disclosure, the electronic device further comprises a memory configured to store at least one configuration information and the processor may control the communication module to transmit configuration information used to configure the electronic device to the media device, if the configuration information available for configuring the media device is not obtained.

According to an embodiment of the present disclosure, the processor may determine first configuration information previously used to configure the media device among the at least one configuration information stored in the memory, based on the received signal.

According to an embodiment of the present disclosure, the processor may control the communication module to transmit the first configuration information to the media device, if the first configuration information is determined.

According to an embodiment of the present disclosure, the processor may determine second configuration information associated with the media device among the at least one configuration information stored in the memory, if the first configuration information is not determined.

According to an embodiment of the present disclosure, the processor may control the communication module to transmit the second configuration information and configuration information used to configure the electronic device to the media device, if the second configuration information is determined.

According to an embodiment of the present disclosure, the processor may control the communication module to transmit a request for at least one of the first configuration information and the second configuration information to a server, if the second configuration information is not determined.

According to an embodiment of the present disclosure, the processor may control the communication module to transmit the first configuration information to the media device, if the first configuration information is received from the server, and to transmit the second configuration information and configuration information used to configure the electronic device to the media device, if the second configuration information is received from the server.

According to an embodiment of the present disclosure, the processor may control the communication module to transmit at least one information obtained in the electronic device to the media device.

According to an embodiment of the present disclosure, the at least one information may include at least one of screen configuration information, font configuration information, voice guide configuration information, and location information of the electronic device.

According to an embodiment of the present disclosure, a method for configuring a first electronic device includes broadcasting, by the first electronic device, a signal comprising information associated with the first electronic device, receiving, by the first electronic device, configuration information transmitted by a second electronic device in response to receiving the signal, determining configuration information available for configuring the first electronic device among the received configuration information and configuring the first electronic device based on the determined configuration information available for configuring the first electronic device.

According to an embodiment of the present disclosure, the information associated with the first electronic device comprises at least one of information regarding a configuration state of the first electronic device, information regarding an operation state of the first electronic device, and device information of the first electronic device.

According to an embodiment of the present disclosure, the configuration information may include at least one of language configuration information, audio configuration information, video configuration information, network configuration information, contents area configuration information, and account configuration information.

According to an embodiment of the present disclosure, the determining of the configuration information available for configuring the first electronic device may include comparing configuration information of the first electronic device with the received configuration information and determining the configuration information available for configuring the first electronic device based on a result of the comparison.

According to an embodiment of the present disclosure, the configuring method may further include displaying a user interface for configuration information that does not correspond to the received configuration information among the configuration information of the first electronic device, if the configuration information of the first electronic device does not the correspond to the received configuration information.

According to an embodiment of the present disclosure, the configuring method may further include receiving at least one information obtained in the second electronic device from the mobile device.

According to an embodiment of the present disclosure, the determining of the configuration information available for configuring the first electronic device may include determining the configuration information available for configuring the electronic device among the received at least one information.

According to an embodiment of the present disclosure, a first electronic device includes a communication module configured to broadcast a signal comprising information associated with the electronic device and to receive configuration information transmitted by a second electronic device in response to receiving the signal and a processor configured to determine configuration information available for configuring the first electronic device among the received configuration information and to configure the first electronic device based on the determined configuration information available for configuring the first electronic device.

According to an embodiment of the present disclosure, the information associated with the first electronic device comprises at least one of information regarding a configuration state of the first electronic device, information regarding an operation state of the first electronic device, and device information of the first electronic device. According to an embodiment of the present disclosure, the configuration information may include at least one of language configuration information, audio configuration information, video configuration information, network configuration information, contents area configuration information, and account configuration information.

According to an embodiment of the present disclosure, the processor may compare configuration information of the first electronic device with the received configuration information and determines the configuration information available for configuring the first electronic device based on a result of the comparison.

According to an embodiment of the present disclosure, the processor may display a user interface for configuration information that does not correspond to the received configuration information among the configuration information of the first electronic device, if the configuration information of the first electronic device does not correspond to the received configuration information.

According to an embodiment of the present disclosure, the communication module may receive at least one information obtained in the second electronic device from the mobile device.

According to an embodiment of the present disclosure, the processor may determine the configuration information available for configuring the first electronic device among the received at least one information.

FIG. 18 is a block diagram 1800 of an example of an electronic device 1801, according to an embodiment of the present disclosure. The electronic device 1801 may include the entire electronic device 101 illustrated in FIG. 1 or a part of the electronic device 101 illustrated in FIG. 1. For example, the electronic device 101 illustrated in FIG. 1 may include the entire electronic device 1801 illustrated in FIG. 18 or a part thereof. The electronic device 1801 may include one or more application processors (APs) 1810, a communication module 1820, a subscriber identification module (SIM) card 1824, a memory 1830, a sensor module 1840, an input module 1850, a display 1860, an interface 1870, an audio module 1880, a camera module 1891, a power management module 1895, a battery 1896, an indicator 1897, and a motor 1898.

The AP 1810 controls multiple hardware or software components connected to the AP 1810 by driving an operating system (OS) or an application program, and performs processing and operations with respect to various data including multimedia data. The AP 1810 may be implemented with, for example, a system on chip (SoC). According to an embodiment, the AP 1810 may further include a graphic processing unit (GPU) and/or an image signal processor. The AP 1810 loads a command or data received from at least one of other elements (e.g., a non-volatile memory) into a volatile memory and processes the command or data and stores various data in the non-volatile memory.

The communication module 1820 may have a configuration that is the same as or similar to the communication module 170 illustrated in FIG. 1. The communication module 1820 may include, for example, the cellular module 1821, a WiFi module 1823, a Bluetooth (BT) module 1825, a global positioning system (GPS) module 1827, a near-field communication (NFC) module 1828, and a radio frequency (RF) module 1829.

The cellular module 1821 may provide, for example, a voice call, a video call, a text service, or an Internet service over a communication network. According to an embodiment, the cellular module 1821 may identify and authenticate the electronic device 1801 in a communication network by using a subscriber identification module (e.g., the SIM card 1824). According to an embodiment, the cellular module 1821 performs at least one of functions that may be provided by the AP 1810. According to an embodiment, the cellular module 1821 may include a communication processor (CP).

At least one of the WiFi module 1823, the BT module 1825, the GPS module 1827, and the NFC module 1828 may include a processor for processing data transmitted and received by a corresponding module. According to some embodiment, at least some (e.g., two or more) of the cellular module 1821, the WiFi module 1823, the BT module 1825, the GPS module 1827, and the NFC module 1828 may be included in one Integrated Chip (IC) or IC package.

The RF module 1829 may transmit and receive a communication signal (e.g., an RF signal). The RF module 1829 may include a transceiver, a power amp module (PAM), a frequency filter, a low noise amplifier (LNA), or an antenna. According to another embodiment, at least one of the cellular module 1821, the WiFi module 1823, the BT module 1825, the GPS module 1827, and the NFC module 1828 may transmit and receive an RF signal through a separate RF module.

The SIM card 1824 may include a card including an SIM and/or an embedded SIM, and may include unique identification information (e.g., an integrated circuit card identifier (ICCID) or subscriber information (e.g., an international mobile subscriber identity (IMSI)).

The memory 1830 (e.g., the memory 130) may include an internal memory 1832 or an external memory 1834. The internal memory 1832 may include at least one of a volatile memory (e.g., dynamic random access memory (DRAM), static RAM (SRAM), synchronous dynamic RAM (SDRAM), and a non-volatile memory (e.g., one time programmable read only memory (OTPROM), programmable ROM (PROM), erasable and programmable ROM (EPROM), electrically erasable and programmable ROM (EEPROM), mask ROM, flash ROM, NAND flash memory, or NOR flash memory), and a solid state drive (SSD).

The external memory 1834 may further include a flash drive, for example, compact flash (CF), secure digital (SD), micro-SD, mini-SD, extreme Digital (xD), a Multimedia Card (MMC), or a memory stick. The external memory 1834 may be functionally and/or physically connected with the electronic device 1801 through various interfaces.

The sensor module 1840 measures physical quantity or senses an operation state of the electronic device 1801 to convert the measured or sensed information into an electric signal. The sensor module 1840 may include at least one of a gesture sensor 1840A, a gyro sensor 1840B, a pressure sensor 1840C, a magnetic sensor 1840D, an acceleration sensor 1840E, a grip sensor 1840F, a proximity sensor 1840G, a color sensor 1840H (e.g., RGB sensor), a biometric sensor 1840I, a temperature/humidity sensor 1840I, an illumination sensor 1840K, and a ultraviolet (UV) sensor 1840M. Additionally or alternatively, the sensor module 1840 may include an e-nose sensor (not shown), an electromyography (EMG) sensor (not shown), an electroencephalogram (EEG) sensor (not shown), an electrocardiogram (ECG) sensor (not shown), or a fingerprint sensor. The sensor module 2040 may further include a control circuit for controlling at least one sensor included therein. In some embodiment, the electronic device 1801 may further include a processor configured to control the sensor module 1840 as part of or separately from the AP 1810, to control the sensor module 1840 during a sleep state of the AP 1810.

The input module 1850 may include a touch panel 1852, a (digital) pen sensor 1854, a key 1856, or an ultrasonic input device 1858. The touch panel 1852 may use at least one of a capacitive type, a resistive type, an IR type, or an ultrasonic type. The touch panel 1852 may further include a control circuit. The touch panel 1852 may further include a tactile layer to provide tactile reaction to the user.

The (digital) pen sensor 1854 may include a recognition sheet which is a part of the touch panel 1852 or a separate recognition sheet. The key 1856 may also include a physical button, an optical key, or a keypad. The ultrasonic input device 1858 senses ultrasonic waves generated in an input means for generating the ultrasonic waves through a microphone (e.g., the microphone 1888) and checks data corresponding to the sensed ultrasonic waves in the electronic device 1801.

The display 1860 (e.g., the display module 160) may include a panel 1862, a hologram device 1864, or a projector 1866. The panel 1862 may have a configuration that is the same as or similar to that of the display 1860 of FIG. 1. The panel 1862 may be implemented to be flexible, transparent, or wearable. The panel 1862 may be configured with the touch panel 1852 in one module. The hologram device 1864 shows a stereoscopic image in the air by using interference of light. The projector 1866 displays an image onto an external screen through projection of light. The screen may be positioned inside or outside the electronic device 1801. According to an embodiment, the display 1860 may further include a control circuit for controlling the panel 1862, the hologram device 1864, or the projector 1866.

The interface 1870 may include a high-definition multimedia interface (HDMI) 1872, a universal serial bus (USB) 1874, an optical communication 1876, or a D-subminiature 1878. The interface 1870 may be included in the communication module 170 illustrated in FIG. 1. Additionally or alternatively, the interface 1870 may include a Mobile High-Definition Link (MHL) interface, an SD/MMC interface, or an infrared data association (IrDA) interface.

The audio module 1880 bi-directionally converts sound and an electric signal. At least one element of the audio module 1880 may be included in the I/O interface 150 illustrated in FIG. 1. The audio module 1880 processes sound information input or output through the speaker 1882, the receiver 1884, the earphone 1886, or the microphone 1888.

The camera module 1891 is a device capable of capturing a still image or a moving image, and according to an embodiment, may include one or more image sensors (e.g., a front sensor or a rear sensor), a lens, an image signal processor (ISP), or a flash (e.g., an LED or a xenon lamp).

The power management module 1895 manages power of the electronic device 1801. According to an embodiment, the power management module 1895 may include a Power management integrated circuit (PMIC), a charger IC, or a battery fuel gauge. The PMIC may have a wired and/or wireless charging scheme. The wireless charging scheme includes a magnetic-resonance type, a magnetic induction type, and an electromagnetic type, and for wireless charging, an additional circuit, for example, a coil loop, a resonance circuit, or a rectifier may be further included. The battery gauge measures the remaining capacity of the battery 1896 or the voltage, current, or temperature of the battery 1896 during charging. The battery 1896 may include a rechargeable battery and/or a solar battery.

The indicator 1897 displays a particular state, for example, a booting state, a message state, or a charging state, of the electronic device 1801 or a part thereof (e.g., the AP 1810). The motor 1898 converts an electric signal into mechanical vibration or generates vibration or a haptic effect. Although not shown, the electronic device 1801 may include a processing device (e.g., a GPU) for supporting a mobile TV. The processing device for supporting the mobile TV processes media data according to, a standard such as digital multimedia broadcasting (DMB), digital video broadcasting (DVB), or mediaFlo™.

Each of the foregoing elements described herein may include one or more components, and a name of the part may vary with a type of the electronic device 2001. The electronic device according to the present disclosure may include at least one of the foregoing elements, and some of the elements may be omitted therefrom, or other elements may be further included therein. As some of the elements of the electronic device according to the present disclosure are coupled into one entity, the same function as those of the elements that have not been coupled may be performed.

A term “module” used herein may mean, for example, a unit including one of or a combination of two or more of hardware, software, and firmware. The “module” may be interchangeably used with a unit, logic, a logical block, a component, or a circuit. The “module” may be a minimum unit or a portion of an integrated component. The “module” may be a minimum unit or a portion thereof performing one or more functions. The “module” may be implemented mechanically or electronically. For example, the “module” according to the embodiments may include at least one of an application-specific integrated circuit (ASIC) chip, field-programmable gate arrays (FPGAs), and a programmable-logic device performing certain operations already known or to be developed.

At least a part of a device (for example, modules or functions thereof) or a method (for example, operations) according to various embodiments of the present disclosure may be implemented with a command stored in a computer-readable storage medium in the form of a program module. When the command is executed by a processor (for example, the processor 120), the one or more processors may perform a function corresponding to the command. The computer-readable storage medium may be, for example, the memory 130.

As is apparent from the foregoing description, according to various embodiments of the present disclosure, the electronic device may transmit configuration information available for configuring the media device to the media device, and the media device may perform configuration based on the received configuration information. In this way, the media device may not be directly configured by the user and configuration of the media device may be automatically performed based on the received configuration information. The media device may configure and provide a driving environment suitable for a user by performing configuration based on the configuration information.

FIGS. 1-18 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples. As used throughout the disclosure, the term “configuration setting” may refer to an alphanumerical string, a word, a number, one or more lines of code, and or any other suitable type of data that specifies the manner in which a hardware or software component of an electronic device is to be operated by the electronic device. As used throughout the disclosure, the term “database” may refer to any suitable entity that is capable of being used for storing information. For example, and without limitation, the “term database” may refer to a relational database, a file, a file system, a file system directory, or a data structure.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. A method for transmitting configuration information to a media device by an electronic device, the method comprising:
receiving a signal comprising information associated with the media device;
obtaining configuration information available for configuring the media device based on the received signal; and
transmitting the obtained configuration information to the media device if the configuration information is obtained.

2. The method of claim 1, wherein the information associated with the media device comprises at least one of information regarding a configuration state of the media device, information regarding an operational state of the media device, and device information of the media device.

3. The method of claim 1, wherein the configuration information comprises at least one of language configuration information, audio configuration information, video configuration information, network configuration information, contents area configuration information, and account configuration information.

4. The method of claim 1, further comprising:
transmitting configuration information used to configure the electronic device to the media device, if the configuration information available for configuring the media device is not obtained.

5. The method of claim 1, wherein the obtaining the configuration information comprises:
determining first configuration information previously used to configure the media device among at least one configuration information stored in a memory of the electronic device, based on the received signal.

6. The method of claim 5, wherein the transmitting of the configuration information to the media device comprises:
transmitting the first configuration information to the media device, if the first configuration information is determined.

7. The method of claim 5, wherein obtaining the configuration information comprises:
determining second configuration information associated with the media device among at least one configuration information stored in the memory, if the first configuration information is not determined.

8. The method of claim 7, wherein the transmitting of the configuration information to the media device comprises:
transmitting the second configuration information and configuration information used to configure the electronic device, to the media device, if the second configuration information is determined.

9. The method of claim 7, further comprising:
transmitting a request for at least one of the first configuration information and the second configuration information to a server, if the second configuration information is not determined.

10. The method of claim 9, further comprising:
transmitting the first configuration information to the media device, if the first configuration information is received from the server; and
transmitting the second configuration information and configuration information used to configure the electronic device to the media device, if the second configuration information is received from the server.

11. The method of claim 1, further comprising:
transmitting at least one information obtained in the electronic device to the media device.

12. The method of claim 11, wherein the at least one information comprises at least one of screen configuration information, font configuration information, voice guide configuration information, and location information of the electronic device.

13. An electronic device for transmitting configuration information to a media device, the electronic device comprising:
a communication module configured to receive a signal comprising information associated with the media device; and
a processor configured to obtain configuration information available for configuring the media device based on the received signal and to transmit the obtained configuration information to the media device if the configuration information is obtained.

14. The electronic device of claim 13, wherein the information associated with the media device comprises at least one of information regarding a configuration state of the media device, information regarding an operational state of the media device, and device information of the media device.

15. The electronic device of claim 13, wherein the configuration information comprises at least one of language configuration information, audio configuration information, video configuration information, network configuration information, contents area configuration information, and account information.

16. The electronic device of claim 13, further comprising:
a memory configured to store at least one configuration information; and
wherein the processor controls the communication module to transmit configuration information used to configure the electronic device to the media device, if the configuration information available for configuring the media device is not obtained.

17. The electronic device of claim 13, further comprising:
a memory configured to store at least one configuration information; and
wherein the processor determines first configuration information previously used to configure the media device among the at least one configuration information stored in the memory, based on the received signal.

18. The electronic device of claim 17, wherein the processor controls the communication module to transmit the first configuration information to the media device, if the first configuration information is determined.

19. The electronic device of claim 17, wherein the processor determines second configuration information associated with the media device among the at least one configuration information stored in the memory, if the first configuration information is not determined.

20. The electronic device of claim 19, wherein the processor controls the communication module to transmit the second configuration information and configuration information used to configure the electronic device, to the media device, if the second configuration information is determined.

21. The electronic device of claim 19, wherein the processor controls the communication module to transmit a request for at least one of the first configuration information and the second configuration information to a server, if the second configuration information is not determined.

22. The electronic device of claim 21, wherein the processor controls the communication module to transmit the first configuration information to the media device, if the first configuration information is received from the server, and to transmit the second configuration information and configuration information used to configure the electronic device to the media device, if the second configuration information is received from the server.

23. The electronic device of claim 13, wherein the processor controls the communication module to transmit at least one information obtained in the electronic device to the media device.

24. The electronic device of claim 23, wherein the at least one information comprises at least one of screen configuration information, font configuration information, voice guide configuration information, and location information of the electronic device.

25. A method for configuring a first electronic device, wherein the method comprising:
broadcasting, by the first electronic device, a signal comprising information associated with the first electronic device;
receiving, by the first electronic device, configuration information transmitted by a second electronic device in response to receiving the signal;
determining configuration information available for configuring the first electronic device among the received configuration information; and
configuring the first electronic device based on the determined configuration information available for configuring the first electronic device.

26. The configuring method of claim 25, wherein the information associated with the first electronic device comprises at least one of information regarding a configuration state of the first electronic device, information regarding an operation state of the first electronic device, and device information of the first electronic device.

27. The configuring method of claim 25, wherein the configuration information comprises at least one of language configuration information, audio configuration information, video configuration information, network configuration information, contents area configuration information, and account configuration information.

28. The configuring method of claim 25, wherein the determining of the configuration information available for configuring the first electronic device comprises:
comparing configuration information of the first electronic device with the received configuration information; and
determining the configuration information available for configuring the first electronic device based on a result of the comparison.

29. The configuring method of claim 28, further comprising:
displaying a user interface for configuration information that does not correspond to the received configuration information among the configuration information of the first electronic device, if the configuration information of the first electronic device does not the correspond to the received configuration information.

30. The configuring method of claim 25, further comprising:
receiving at least one information obtained in the second electronic device from the mobile device.

31. The configuring method of claim 30, wherein the determining of the configuration information available for configuring the first electronic device comprises:
determining the configuration information available for configuring the electronic device among the received at least one information.

32. A first electronic device comprising:
a communication module configured to broadcast a signal comprising information associated with the electronic device and to receive configuration information transmitted by a second electronic device in response to receiving the signal; and
a processor configured to determine configuration information available for configuring the first electronic device among the received configuration information and to configure the first electronic device based on the determined configuration information available for configuring the first electronic device.

33. The electronic device of claim 32, wherein the information associated with the first electronic device comprises at least one of information regarding a configuration state of the first electronic device, information regarding an operation state of the first electronic device, and device information of the first electronic device.

34. The electronic device of claim 32, wherein the configuration information comprises at least one of language configuration information, audio configuration information, video configuration information, network configuration information, contents area configuration information, and account configuration information.

35. The electronic device of claim 32, wherein the processor compares configuration information of the first electronic device with the received configuration information and determines the configuration information available for configuring the first electronic device based on a result of the comparison.

36. The electronic device of claim 35, wherein the processor displays a user interface for configuration information that does not correspond to the received configuration information among the configuration information of the first electronic device, if the configuration information of the first electronic device does not correspond to the received configuration information.

37. The electronic device of claim 32, wherein the communication module receives at least one information obtained in the second electronic device from the mobile device.

38. The electronic device of claim 37, wherein the processor determines the configuration information available for configuring the first electronic device among the received at least one information.
